(19) United States
(12) Patent Application Publication
(10) Pub. No.: US 2018/0086253 A1
(43) Pub. Date: Mar. 29, 2018

(54) Light Beam Assembly for Use with Trailers for Trucks

(71) Applicant: Chris Bratcher, Hutchinson, KS (US)

(72) Inventor: Chris Bratcher, Hutchinson, KS (US)

(21) Appl. No.: 15/280,539

(22) Filed: Sep. 29, 2016

(51) Int. Cl. B60Q 1/34; B60Q 1/32; B60Q 1/26

(52) U.S. Cl. CPC B60Q 1/34; B60Q 1/2615; B60Q 1/32

(57) ABSTRACT

A light projector assembly for use with a trailer and a truck is presented. The light projector assembly is mountable to the trailer in proximity to where a tail light blinker assembly is attached, e.g. directly underneath the truck. The light projector assembly operates in sync with the tail light assembly, i.e when the tail light is activated by the driver of the truck, the light projector assembly and tail light assembly are both activated. The light projector assembly includes a lamp that when activated by the truck operator to indicate a direction of travel causes a stream of light to project from the trailer at angles to the horizontal and vertical of the trailer so that the beam of light is projected down on the ground in a way that indicates a distance between the back of the trailer and the end of the beam of light.

### TECHNICAL FIELD

The present invention relates to the field of tail light assemblies and the use of such with trailers and trucks and, more specifically a light beam assembly used in conjunction with tail light assemblies to provide to a driver of a truck indication of clearance between a trailer of the truck and automobiles behind the trailer.

### BACKGROUND

The United States (US) highway system can be a dangerous place and many deaths occur each year because negligent drivers. Over the years, the US government as well as insurance companies have instituted laws and policies to help make US roads and highway system a safer place. This is evidenced by the laws implemented by the US and state governments and the penalties imposed for everything from minor infractions, e.g. not wearing a seat belt, to major infractions, such as driving while intoxicated. Not only will the law penalize drivers and companies for these infractions but also insurance companies will implement and impose policies that result in stiffer insurance rates for those that do not follow the law. Due to these penalties and policies, our highways and roads have become a safer place over the years. Not only does the government and insurance companies benefit but so does the public. It only stands to reason, therefore, any tool or instrument that can help make our roads and highways safer would be a benefit to all involved.

A particular issue, especially on our highway systems, is the amount of traffic and accidents due to long haul carriers. The job for these long haul carriers, i.e. one hauling freight across our highway system, can be daunting. The demands to get a job done can put pressure on these truck operators that most will never experience. There are issues with the number of hours that must be logged to get a job done. There are issues with dealing with other drivers. There are issues with the expertise needed to manage these long haul trucks. These long haul trucks typically consist of a long haul rig, or rather a semi-truck, and a trailer for moving cargo across the country. A driver of the long haul truck needs to maneuver the rig and trailer safely on our highway systems. A particular problem, however, may be the driver of the long haul rig may or may not be very experienced, or may be fatigued and as such his or her judgment may not be what it should be, and other drivers in vicinity may be the same. In this situation, maneuvering the vehicle on our highway system may become a problem. For example, a driver of a long haul truck may wish to pass another driver on the road. Considering the truck and the automobile may be moving upwards of 60 miles per hour, fatigue of the driver or drivers, and the extended length of the trailer, passing the vehicle and entering back into the lane of the vehicle could become dangerous if the driver of the truck does not compensate enough for the distance between. This could obviously result in a bad accident.

As such, there is a need for a light assembly that can be used on trailers for trucks that when used will allow the truck driver to better estimate the clearance between the tail of the trailer and an automobile behind the trailer.

### SUMMARY

The example embodiments presented herein meet the above-identified needs by providing a light projector assembly for use with a trailer and a truck. The light projector assembly can be mounted to the trailer in proximity to where a tail light blinker assembly is attached. The light projector assembly can operate in sync with the tail light assembly, i.e when the tail light is activated by the driver of the truck, the light projector assembly and tail light assembly are both activated. The light projector assembly includes a lamp that when activated by the truck operator to indicate a direction of travel causes a stream of light to project from the trailer at angles to the horizontal and vertical of the trailer so that the beam of light is projected down on the ground in a way that indicates a distance between the back of the trailer and the end of the beam of light.

In an embodiment, the light projector assembly includes a mounting bracket attached to the trailer in proximity to the tail light blinker assembly. The light projector assembly further includes a light beam assembly that is mounted to the mounting bracket, wherein the light beam assembly produces a beam of light in response to the activation of the tail light blinker. The light beam assembly produces a stream of light wherein the stream is projected at an angle from the horizontal base of the trailer and at an angle from the vertical base of the trailer. The stream of light projected is at angles that result in the stream of light projected indicating a spacial distance from the end of the trailer to the end of the stream of light.

### BRIEF DESCRIPTION OF THE DRAWINGS

FIG. 1A is a perspective view of a long haul truck that uses a tail light assembly according to an embodiment of the invention.

FIG. 1B is an alternative view of the long haul truck that uses a tail light assembly according to an embodiment of the invention.

FIG. 2 is a front view of an assembled light projector assembly for coupling with a trailer of a truck according to an embodiment of the invention.

FIG. 3 is a side view of the light beam assembly according to an embodiment of the invention.

FIG. 4 is a is a back view of the mounting bracket according to an embodiment of the invention.

FIG. 5 is a perspective view of an light projector assembly according to an embodiment of the invention.

### DETAILED DESCRIPTION OF THE PRESENTLY PREFERRED EMBODIMENTS

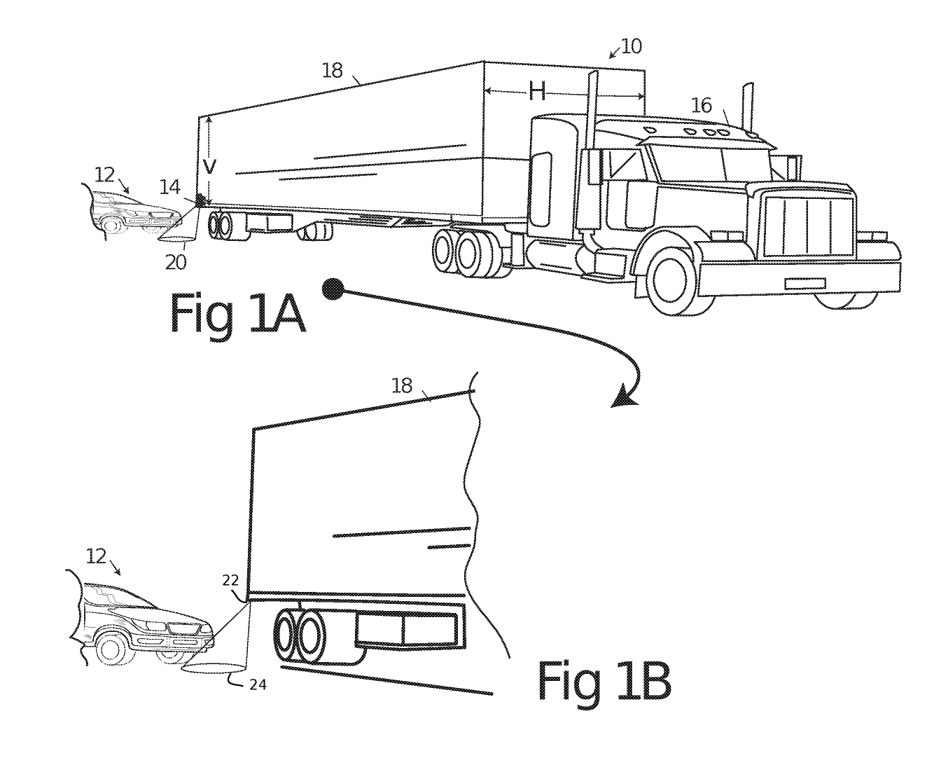

Referring to FIG. 1A, illustrated is a perspective view of a long haul truck 10 maneuvering around an automobile 12 using a light projector assembly 14 according to an embodiment of the invention. In the embodiment, the long haul truck 10 comprises a rig 16, a trailer 18 with horizontal (H) dimensions (horizontal with the ground), or width, and vertical dimensions (V), or height, and the light projector assembly 14 mounted on the tail end of the trailer 18 at the bock along the horizontal of the trailer's base at a predetermined height.

In use, the operator of the rig 16 may wish to pass the automobile 12 on the highway and the driver of the long haul truck 10 will indicate to the driver of the automobile 12 when the long haul truck 10 is to re-enter the lane of the automobile 12 by using the rig's turn signals. In response, the light projector assembly will in conjunction with activation of the turn signal activate the light projector assembly 14. Activation of the assembly 14 will result in a beam of light 20 projecting down onto the road traveled. The beam of light 20 projected passes under the cab of the automobile 12 and eventually onto the road in front of the automobile 12. When the beam of light projected 22 passes the front of the vehicle and the operator of the truck 10 can see the beam of light in front of the automobile 12, the operator of the truck 10 can safely pass the automobile.

Referring to FIG. 1B, illustrated is an alternative perspective view of the long haul truck that uses a light projector assembly 22 positioned in an alternative place on the trailer 18. In this embodiment, the light projector assembly 14 is positioned under the carriage of the trailer 18 and a light projected 24 is of a more narrow beam. The positioning of the assembly 14 in this embodiment is to make the assembly 22 more discrete so that it can't injure someone or be knocked off the trailer 22. However, it should be understood that the placement of the assembly may mounted at any locations along the trailer 18 that could result in the beam of light projected 24 allowing the operator of the rig 16 to understand the clearance between trailer 18 and automobile 18.

In either FIGS. 1A and 1B, the light beam assembly produces a stream of light wherein the stream is projected at an angle from the horizontal base of the trailer and at an angle from the vertical base of the trailer. The light projector assembly projects a stream of light at angles that result in the stream of light projected indicating a spacial distance from the end of the trailer to the end of the stream of light. The distance is not specified but it would be a distance that would provide safe clearance between the trailer of the long haul truck and the automobile being passed.

Referring to FIG. 2, illustrated is a front view of an assembled light projector assembly for coupling with a trailer of a truck and is denoted generally as 50. The light projector assembly 50 includes a mounting bracket 52 that is couple-able to a trailer through mounting holes 54A-D. The assembled light projector 50 further includes a light beam assembly 56 mountable to the mounting bracket 52. The light beam assembly 56 includes a lamp 58, e.g. an LED lamp. The lamp 58 is capable of producing a beam of light in response to the activation of the a light blinker from the long haul truck.

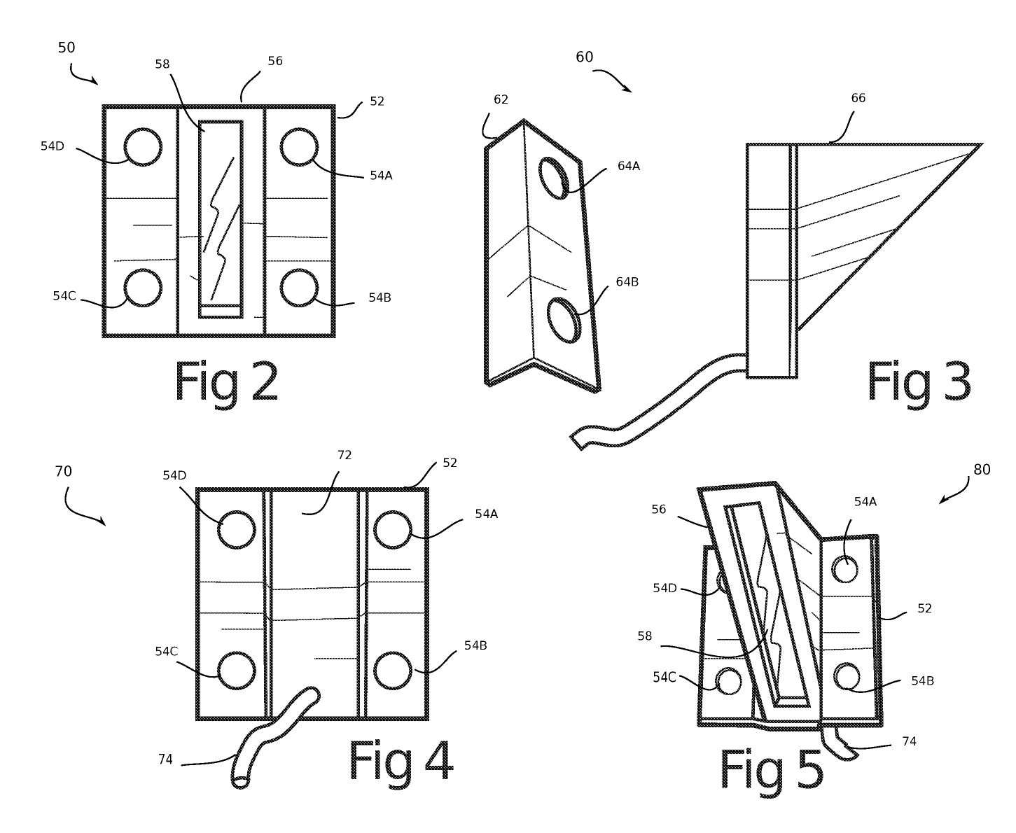

Referring to FIG. 3, illustrated is a side view of the light beam assembly 56 denoted generally as 60. The light beam assembly 60 includes a mounting bracket 62 with mounting holes 64A,B that couples an LED housing unit 66 with the mounting bracket 52. The LED housing unit 66 includes a LED that is coupled with an electronic control unit of the long haul truck so that the LED is operational signals provided when a turn signal is activated.

Referring to FIG. 4, illustrated is a back view of the mounting bracket 52 and is denoted generally 70. The mounting bracket 52 includes mounting holes 54A-D and an area 72 for receiving the LED housing unit 66. The area 72 includes an aperture for receiving a conductive medium 74 from the electronic control unit.

Referring to FIG. 5, illustrated is a perspective view of an light projector assembly denoted generally as 80. The light projector assembly 80 includes the mounting bracket 52, mounting holes 54A-D, light beam assembly 56, lamp 58, and the conductive medium 74. FIGS. 2 through 5 are merely illustrative and describe one implementation method of coupling the light projector assembly 80 with a trailer of a semi rig or other type of truck. Depending on the trailer, the actual configuration of the mounting brackets and light beam assembly may be different but the spirit of the invention remains the same.

Thus, While there have been shown and described and pointed out fundamental novel features of the invention as applied to a preferred embodiment thereof, it will be under stood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same Way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A light projector assembly for use with a trailer and a truck, wherein a tail light blinker assembly is attached to the trailer and operates pursuant to truck operator directives in a manner that activates the tail light blinker so that a blinking light is generated that can indicate direction of travel for the truck and the trailer, the light projector assembly comprising:
a mounting bracket couple-able to the trailer in proximity to the tail light blinker assembly;
a light beam assembly mountable to the mounting bracket, wherein the light beam assembly produces a beam of light in response to the activation of the tail light blinker; and
the light beam assembly produces a stream of light wherein the stream is projected at an angle from the horizontal base of the trailer and at an angle from the vertical base of the trailer.

2. The light projector assembly as recited in claim 1 wherein the mounting bracket is couple-able underneath the trailer.

3. The light projector assembly as recited in claim 1 wherein the mounting bracket is couple-able on the side of the trailer.

4. The light projector assembly as recited in claim 1 wherein the mounting bracket is couple-able on the back of the trailer.

5. The light projector assembly as recited in claim 1 wherein the stream of light projected is at angles that result in the stream of light projected indicating a spacial distance from the end of the trailer to the end of the stream of light.

6. The light projector assembly as recited in claim 1 wherein the stream of light projected is a narrow stream of light.

7. The light projector assembly as recited in claim 1 wherein the light beam assembly stops producing the stream of light in response to the deactivation of the tail light blinker.
